(19) United States
(12) Patent Application Publication
(10) Pub. No.: US 2025/0027530 A1
(43) Pub. Date: Jan. 23, 2025

(54) STUB SHAFT, POWER TRANSMISSION SHAFT, AND METHOD FOR MANUFACTURING A STUB SHAFT

(71) Applicant: Hitachi Astemo, Ltd., Hitachinaka-shi, Ibaraki (JP)

(72) Inventors: Yasushi AKITA, Hitachinaka-shi, Ibaraki (JP); Kenichiro ISHIKURA, Hitachinaka-shi, Ibaraki (JP)

(73) Assignee: Hitachi Astemo, Ltd., Hitachinaka-shi, Ibaraki (JP)

(21) Appl. No.: 18/024,661

(22) PCT Filed: Aug. 10, 2021
(86) PCT No.: PCT/JP2021/029489

§ 371 Date: Mar. 3, 2023

(30) Foreign Application Priority Data
Sep. 17, 2020 (JP) 2020-156248

(51) Int. Cl. F16C 3/02

(52) U.S. Cl. CPC F16C 3/02

(57) ABSTRACT

A stub shaft is configured in the following manner. A shaft portion connected to a flange portion includes a first outer diameter portion and a second outer diameter portion smaller in diameter than the first outer diameter portion. Assuming that a boundary portion refers to a portion where an imaginary line, which forms an angle of 45 degrees with a rotational axis, overlaps a surface between the flange portion and the shaft portion in a cross-section passing through the rotational axis, and an X-axis direction refers to a direction along the rotational axis, a heat hardening treatment portion is provided on the shaft portion side with respect to the boundary portion in the X-axis direction.

### TECHNICAL FIELD

The present invention relates to a stub shaft, a power transmission shaft, and a method for manufacturing a stub shaft.

### BACKGROUND ART

PTL 1 discloses a propeller shaft including a pipe portion connected to a rotational shaft that transmits a driving force of a vehicle, and a stub shaft that receives the rotational force from the pipe portion. The stub shaft includes a flange portion welded to the pipe portion, and a shaft portion connected to the flange portion.

### CITATION LIST

### Patent Literature

PTL 1: Japanese Patent Application Public Disclosure No. 2018-159404

### SUMMARY OF INVENTION

### Technical Problem

In response to a demand for weight saving, the shaft portion of the stub shaft is smaller in diameter than the flange portion welded to the pipe portion, and is processed by a heat hardening treatment on the surface thereof to secure the strength. According to the conventional stub shaft, the flange portion and the shaft portion are located adjacent to each other. Therefore, when the heat hardening treatment is applied, the flange portion may be thermally affected and be subjected to so-called hardening deep through the thickness thereof, thereby ending up being extremely embrittled. This raises a problem of prohibiting a reduction in the thickness of the large-diameter flange portion and hindering the weight saving.

An object of the present invention is to provide a stub shaft, a power transmission shaft, and a method for manufacturing a stub shaft capable of achieving weight saving as a whole while securing the strength of a shaft portion.

### Solution to Problem

According to one aspect of the present invention, a stub shaft is configured in the following manner. A shaft portion connected to a flange portion includes a first outer diameter portion and a second outer diameter portion smaller in diameter than the first outer diameter portion. Assuming that a boundary portion refers to a portion where an imaginary line, which forms an angle of 45 degrees with a rotational axis, overlaps a surface between the flange portion and the shaft portion in a cross-section passing through the rotational axis, and an axial direction refers to a direction along the rotational axis, a heat hardening treatment portion is provided on the shaft portion side with respect to the boundary portion in the axial direction.

### Advantageous Effects of Invention

Therefore, according to the one aspect of the present invention, it is possible to achieve the weight saving as a whole while securing the strength of the shaft portion.

### BRIEF DESCRIPTION OF DRAWINGS

FIG. 1 is a side view of a propeller shaft 1 according to a first embodiment with a part thereof illustrated in cross-section.

FIG. 2 is a side view of a stub shaft 10 according to the first embodiment with a part thereof illustrated in cross-section.

FIG. 3 illustrates a process for forming a heat hardening treatment portion 17 in a method for manufacturing the stub shaft 10 according to the first embodiment.

FIG. 4 is a side view of a stub shaft 20 according to a second embodiment with a part thereof illustrated in cross-section.

### DESCRIPTION OF EMBODIMENTS

### First Embodiment

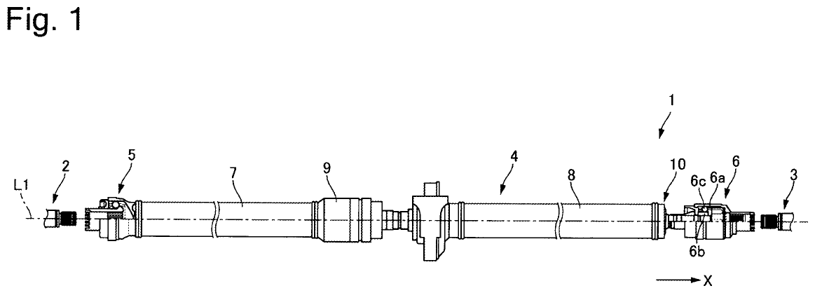

FIG. 1 is a side view of a propeller shaft 1 according to a first embodiment with a part thereof illustrated in cross-section.

The propeller shaft 1 as a power transmission shaft functions to transmit a rotation of an engine serving as a driving source of a vehicle to a drive wheel, and is interposed between an input shaft 2 and an output shaft 3. The input shaft 2 is a vehicle-side rotational shaft portion connected to a not-illustrated transmission located on the engine side. The output shaft 3 is connected to a not-illustrated differential gear located on the drive wheel side. The input shaft 2 and the output shaft 3 are coaxially disposed.

The propeller shaft 1 includes a shaft 4, a first constant-velocity joint 5, and a second constant-velocity joint 6. The shaft 4 is disposed concentrically with the rotational axis of the input shaft 2 and the output shaft 3. Hereinafter, the rotational axis shared among the input shaft 2, the output shaft 3, and the shaft 4 will be referred to as a rotational axis L1, and a direction along the rotational axis L1, a radial direction with respect to the rotational axis L1, and a direction around the rotational axis L1 will be referred to as an axial direction, a radial direction, and a circumferential direction, respectively. Further, an X axis is set to the axial direction, and a direction from the input shaft 2 toward the output shaft 3 and the opposite direction therefrom in the axial direction will be referred to as an X-axis positive direction and an X-axis negative direction, respectively.

The first constant-velocity joint 5 is disposed at the X-axis negative direction end of the shaft 4 in the X-axis direction, and integrally rotatably connects the input shaft 2 and the shaft 4. The second constant-velocity joint 6 is disposed at the X-axis positive direction end of the shaft 4 in the X-axis direction, and integrally rotatably connects the shaft 4 and the output shaft 3. The shaft 4 has a divided structure including a drive shaft 7, a driven shaft (a pipe portion) 8, and a third constant-velocity joint 9. The drive shaft 7 is made from a ferrous alloy, and is connected to the input shaft 2 via the first constant-velocity joint 5. The driven shaft 8 is made from a ferrous alloy, and is connected to the output shaft 3 via the second constant-velocity joint 6. The third constant-velocity joint 9 connects the ends of both the shafts 7 and 8 that face each other therebetween.

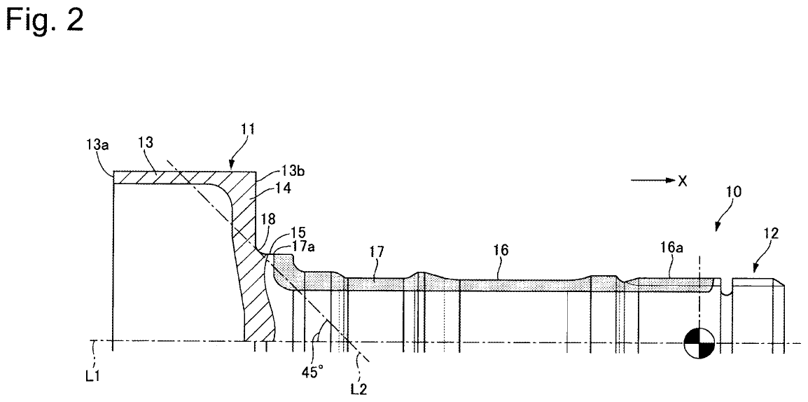

The second constant-velocity joint 6 is a so-called an outer race fixation-type constant-velocity joint that includes an outer race member 6a, an inner race member 6b, and a plurality of balls 6c, and fixedly connects the output shaft 3 to the outer race member 6a. The inner race member 6b of the second constant-velocity joint 6 is connected to the driven shaft 8 via a stub shaft 10. FIG. 2 is a side view of the stub shaft 10 according to the first embodiment with a part thereof illustrated in cross-section.

The stub shaft 10 includes a flange portion 11 and a shaft portion 12.

The flange portion 11 includes a tubular portion 13 and a bottom portion 14. The tubular portion 13 is hollowly formed, and includes an X-axis negative direction-side end portion 13a (a first end portion) and an X-axis positive direction-side end portion (a second end portion) 13b, which are the both end portions thereof in the X-axis direction. The X-axis negative direction-side end portion 13a of these end portions is welded to the driven shaft 8. The bottom portion 14 is provided on the X-axis positive direction-side end portion 13b side of the tubular portion 13 in the X-axis direction, and serves as the bottom of the tubular portion 13.

The shaft portion 12 is connected to the flange portion 11, and is solidly formed. The shaft portion 12 includes a first outer diameter portion 15 and a second outer diameter portion 16. The first outer diameter portion 15 extends from the bottom portion 14 to the X-axis positive direction side, and is formed so as to have a diameter smaller than the flange portion 11. The length from the rotational axis L1 to the surface of the first outer diameter portion 15 is longer than the length of the first outer diameter portion 15 in the X-axis direction. The second outer diameter portion 16 extends from the first outer diameter portion 15 to the X-axis positive direction side, and is formed so as to have a diameter smaller than the first outer diameter portion 15. A spline 16a is provided at the end portion of the second outer diameter portion 16 on the X-axis positive direction side. The spline 16a is splined to a not-illustrated spline hole formed in the inner race member 6b of the second constant-velocity joint 6. This allows the driven shaft 8 and the inner race member 6b to be integrally rotated.

A heat hardening treatment portion 17 for strength reinforcement is provided on the surface of the shaft portion 12. The heat hardening treatment portion 17 is a high-frequency quenching portion (high-frequency hardening or induction hardening) processed by quench hardening using a high frequency. Assuming that an imaginary line L2 refers to an imaginary line that forms an angle of 45 degrees with the rotational axis L1 and a boundary portion 18 refers to a portion where the imaginary line L2 overlaps the surface between the flange portion 11 and the shaft portion 12 (an inner R portion) in a cross-section passing through the rotational axis L1, the heat hardening treatment portion 17 is provided on the positive direction side, i.e., the shaft portion 12 side with respect to the boundary portion 18 in the X-axis direction. In other words, the heat hardening treatment portion 17 is not provided on the X-axis negative direction side, i.e., the bottom portion 14 side of the flange portion 11 with respect to the boundary portion 18. Then, an end portion 17a of the heat hardening treatment portion 17 on the X-axis negative direction side is provided on the surface of the first outer diameter portion 15 in the X-axis direction.

The radially inner side of the boundary portion 18 is solidly formed. Further, the tubular portion 13 of the flange portion 11 is formed so as to have surface hardness equal to or lower than 80% of the heat hardening treatment portion 17.

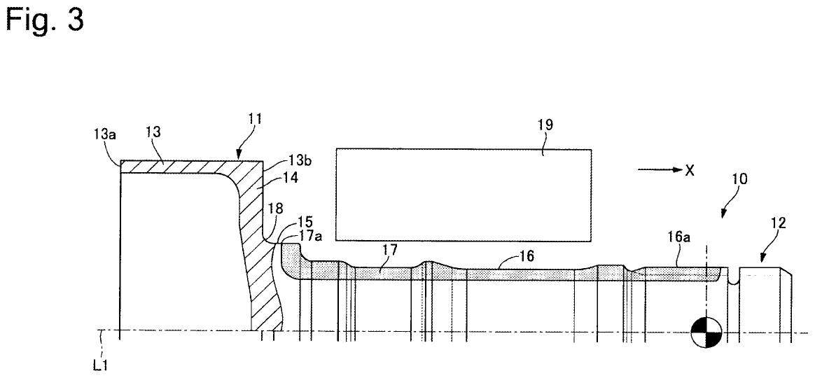

FIG. 3 illustrates a process for forming the heat hardening treatment portion 17 in a method for manufacturing the stub shaft 10 according to the first embodiment.

The method for manufacturing the stub shaft 10 includes a placement step and a high-frequency quenching step. In the placement step, the second outer diameter portion 16 of the shaft portion 12 is placed inside an annular coil 19 used in the heat hardening treatment. In the high-frequency quenching step, the heat hardening treatment portion 17 is formed by moving the coil 19 from the end portion of the second outer diameter portion 16 to a position just before the boundary portion 18 in the X-axis direction.

Next, advantageous effects of the first embodiment will be described.

The stub shaft 10 according to the first embodiment is configured in the following manner. The shaft portion 12 connected to the flange portion 11 includes the first outer diameter portion 15 and the second outer diameter portion 16 smaller in diameter than the first outer diameter portion 15. Assuming that the boundary portion 18 refers to the portion where the imaginary line L2, which forms the angle of 45 degrees with the rotational axis L1, overlaps the surface between the flange portion 11 and the shaft portion 12 (the inner R portion) in the cross-section passing through the rotational axis L1, and the X-axis direction refers to the direction along the rotational axis L1, the heat hardening treatment portion 17 is provided on the shaft portion 12 side with respect to the boundary portion 18 in the X-axis direction. In other words, a step portion (the first outer diameter portion 15) larger than the diameter required to enhance the strength in terms of the strength is provided on the shaft portion 12 side. The stub shaft 10 according to the first embodiment does not include the heat hardening treatment portion 17 on the flange portion 11, thereby being able to prevent the flange portion 11 (the bottom portion 14 thereof) from being hardened deep therethrough. This eliminates the necessity of enhancing the strength of the flange portion 11, thereby allowing the flange portion 11 to be reduced in thickness. The radially inner sides of the first outer diameter portion 15 and the boundary portion 18 are solid, and therefore are not embrittled due to the heat influence of the heat hardening treatment. Further, since the first outer diameter portion 15 is smaller in diameter than the flange portion 11, the weight saving of the stub shaft 10 is not hindered. As a result, the stub shaft 10 according to the first embodiment can achieve the weight saving thereof while securing the strength of the shaft portion 12.

The heat hardening treatment portion 17 is the high-frequency quenching portion processed by quench hardening using a high frequency. The high-frequency quenching is highly thermally efficient and also takes only a short work time, thereby allowing the cost to reduce due to energy saving and labor-saving and allowing the stub shaft 10 to be manufactured inexpensively.

Since the end portion 17a of the heat hardening treatment portion 17 is provided on the surface of the first outer diameter portion 15, the first embodiment can reliably apply the high-frequency quenching to the first outer diameter portion 15 to enhance the strength of the shaft portion 12.

The tubular portion 13 is formed so as to have surface hardness equal to or lower than 80% of the surface hardness of the heat hardening treatment portion 17. This means that the tubular portion 13 is unaffected by the heat treatment, and therefore the first embodiment can prevent the tubular portion 13 from being hardened deep therethrough and allow the tubular portion 13 to be reduced in thickness. As a result, the first embodiment can achieve the weight saving of the stub shaft 10 while securing the strength of the shaft portion 12.

The length from the rotational axis L1 to the surface of the first outer diameter portion 15 is longer than the length of the first outer diameter portion 15 in the X-axis direction. In other words, the first embodiment can achieve both the securement of the strength and the weight saving by reducing the length of the first outer diameter portion 15 in the X-axis direction as much as possible while securing the diameter required to ensure the strength.

The method for manufacturing the stub shaft 10 according to the first embodiment includes the placement step of placing the second outer diameter portion 16 of the shaft portion 12 inside the annular coil 19 used in the heat hardening treatment and the high-frequency quenching step of forming the heat hardening treatment portion 17 by moving the coil 19 from the end portion of the second outer diameter portion 16 to the position just before the boundary portion 18 in the X-axis direction. As a result, the first embodiment can prevent the flange portion 11 from being hardened deep therethrough while securing the strength of the shaft portion 12 by reliably applying the high-frequency quenching to the first outer diameter portion 15.

### Second Embodiment

A second embodiment has a basic configuration similar to the first embodiment, and therefore will be described focusing on only differences from the first embodiment.

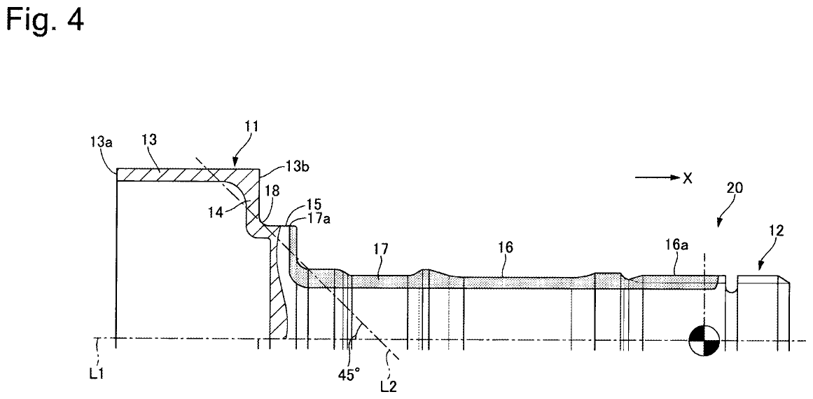

FIG. 4 is a side view of a stub shaft 20 according to the second embodiment with a part thereof illustrated in cross-section.

In the stub shaft 20 according to the second embodiment, the radially inner sides of the bottom portion 14 and the first outer diameter portion 15 are partially hollowly formed. Therefore, the radially inner side of the boundary portion 18 is also hollow.

The heat hardening treatment portion 17 is a laser quenching portion (laser hardening portion) processed by quench hardening using a laser. The end portion 17a of the heat hardening treatment portion 17 is provided on the X-axis positive direction side, i.e., on the second outer diameter portion 16 side with respect to the central portion of the first outer diameter portion 15. The radially inner side of the heat hardening treatment portion 17 is solidly formed.

The second embodiment forms the heat hardening treatment portion 17 as the laser quenching portion, thereby being able to accurately form the quenching range compared to the configuration in which the heat hardening treatment portion 17 is formed as the high-frequency quenching portion. As a result, the second embodiment can further reliably prevent the tubular portion 13 from being hardened deep therethrough.

Further, the weight saving of the stub shaft 20 can be achieved by hollowly forming the radially inner side of the boundary portion 18. The radially inner side of the heat hardening treatment portion 17 is solid, and therefore the strength of the shaft portion 12 is not reduced.

Further, the end portion 17a of the heat hardening treatment portion 17 is provided on the second outer diameter portion 16 side with respect to the central portion of the first outer diameter portion 15 in the X-axis direction. Accordingly, an optimal heat hardening treatment can be realized.

### Other Embodiments

Having described the embodiments for implementing the present invention, the specific configuration of the present invention is not limited to the configurations of the embodiments, and the present invention also includes even a design modification and the like thereof made within a range that does not depart from the spirit of the present invention, if any.

For example, the shape of the portion where the flange portion and the shaft portion are connected is not limited to the inner R shape.

Further, the shape of the power transmission shaft is not limited to the propeller shaft 1 according to the first embodiment.

In the following description, technical ideas recognizable from the above-described embodiments will be described.

A stub shaft, in one configuration thereof, includes a flange portion welded to a pipe portion connected to a rotational shaft configured to transmit a driving force of a vehicle. The flange portion includes a tubular portion and a bottom portion. The tubular portion is hollowly formed. The tubular portion has a first end portion and a second end portion, which are both end portions in an axial direction, assuming that the axial direction is a direction along a rotational axis of the rotational shaft. The first end portion of the two end portions is welded to the pipe portion. The bottom portion is provided on the second end portion side of the tubular portion. The bottom portion serves as a bottom of the tubular portion. The stub shaft further includes a shaft portion connected to the flange portion and having a first outer diameter portion and a second outer diameter portion. The first outer diameter portion is connected to the bottom portion. The first outer diameter portion is formed so as to have a diameter smaller than the flange portion in a radial direction with respect to the rotational axis. The second outer diameter portion is connected to the first outer diameter portion. The second outer diameter portion is formed so as to have a diameter smaller than the first outer diameter portion in the radial direction. The stub shaft further includes a heat hardening treatment portion provided on a surface of the shaft portion. The heat hardening treatment portion is provided on the shaft portion side with respect to a boundary portion in the axial direction, assuming that the boundary portion is a portion where an imaginary line forming an angle of 45 degrees with the rotational axis overlaps a surface between the flange portion and the shaft portion in a cross-section passing through the rotational axis.

Preferably, in the above-described configuration, the heat hardening treatment portion is not provided on the bottom portion side of the flange portion with respect to the boundary portion.

In another preferable configuration, in any of the above-described configurations, the heat hardening treatment portion is a high-frequency quenching portion processed by quench hardening using a high frequency.

In further another preferable configuration, in any of the above-described configurations, the heat hardening treatment portion is a laser quenching portion processed by quench hardening using a laser.

In further another preferable configuration, in any of the above-described configurations, an end portion of the heat hardening treatment portion is provided on a surface of the first outer diameter portion.

In further another preferable configuration, in any of the above-described configurations, the end portion of the heat hardening treatment portion is provided on the second outer diameter portion side with respect to a central portion of the first outer diameter portion in the axial direction.

In further another preferable configuration, in the above-described configuration, an inner side of the boundary portion in the radial direction is solidly formed.

In further another preferable configuration, in the above-described configuration, an inner side of the boundary portion in the radial direction is hollowly formed.

In further another preferable configuration, in the above-described configuration, the tubular portion is formed so as to have surface hardness equal to or lower than 80% of surface hardness of the heat hardening treatment portion.

In further another preferable configuration, in the above-described configuration, a length from the rotational axis to the surface of the first outer diameter portion is longer than a length of the first outer diameter portion in the axial direction.

From another aspect, a propeller shaft, in one configuration, includes a pipe portion connected to a rotational shaft configured to transmit a driving force of a vehicle, and a stub shaft. The stub shaft includes a flange portion welded to the pipe portion and including a tubular portion and a bottom portion. The tubular portion is hollowly formed. The tubular portion has a first end portion and a second end portion, which are both end portions in an axial direction, assuming that the axial direction is a direction along a rotational axis of the rotational shaft. The first end portion of the two end portions is welded to the pipe portion. The bottom portion is provided on the second end portion side. The bottom portion serves as a bottom of the tubular portion. The stub shaft further includes a shaft portion connected to the flange portion and having an intermediate portion and a thin shaft portion. The intermediate portion is connected to the bottom portion. The intermediate portion is formed so as to have a diameter smaller than the flange portion in a radial direction with respect to the rotational axis. The thin shaft portion is connected to the intermediate portion. The thin shaft portion is formed so as to have a diameter smaller than the intermediate portion in the radial direction. The stub shaft further includes a heat hardening treatment portion provided on a surface of the shaft portion. The heat hardening treatment portion is provided on the shaft portion side with respect to a boundary portion in the axial direction, assuming that the boundary portion is a portion where an imaginary line forming an angle of 45 degrees with the rotational axis is connected to a surface between the flange portion and the shaft portion in a cross-section passing through the rotational axis.

Further, from another aspect, a method for manufacturing a stub shaft, in one configuration, is configured in the following manner. The stub shaft includes a flange portion including a tubular portion and a bottom portion. The tubular portion is hollowly formed. The tubular portion has a first end portion and a second end portion, which are both end portions in an axial direction, assuming that the axial direction is a direction along a rotational axis of the rotational shaft. The first end portion of the two end portions is welded to a pipe portion connected to the rotational shaft configured to transmit a driving force of a vehicle. The bottom portion is provided on the second end portion side. The bottom portion serves as a bottom of the tubular portion. The stub shaft further includes a shaft portion connected to the flange portion and having a first outer diameter portion and a second outer diameter portion. The first outer diameter portion is connected to the bottom portion. The first outer diameter portion is formed so as to have a diameter smaller than the flange portion in a radial direction with respect to the rotational axis. The second outer diameter portion is connected to the first outer diameter portion. The second outer diameter portion is formed so as to have a diameter smaller than the first outer diameter portion in the radial direction. The stub shaft further includes a heat hardening treatment portion provided on a surface of the shaft portion. The heat hardening treatment portion is provided on the shaft portion side with respect to a boundary portion in the axial direction, assuming that the boundary portion is a portion where an imaginary line forming an angle of 45 degrees with the rotational axis overlaps a surface between the flange portion and the shaft portion in a cross-section passing through the rotational axis. The method for manufacturing the stub shaft includes a placement step of placing the second outer diameter portion of the shaft portion inside an annular coil used in a heat hardening treatment, and a high-frequency quenching step of forming the heat hardening treatment portion by moving the coil from an end portion of the second outer diameter portion to a position just before the boundary portion in the axial direction.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2020-156248 filed on Sep. 17, 2020. The entire disclosure of Japanese Patent Application No. 2020-156248 filed on Sep. 17, 2020 including the specification, the claims, the drawings, and the abstract is incorporated herein by reference in its entirety.

### REFERENCE SIGNS LIST

1 propeller shaft
2 input shaft
3 output shaft
4 shaft
5 first constant-velocity joint
6 second constant-velocity joint
6a outer race member
6b inner race member
6c ball
7 drive shaft
8 driven shaft (pipe portion)
9 third constant-velocity joint
10 stub shaft
11 flange portion
12 shaft portion
13 tubular portion
13a X-axis negative direction-side end portion (first end portion)
13b X-axis positive direction-side end portion (second end portion)
14 bottom portion
15 first outer diameter portion
16 second outer diameter portion
16a spline
17 heat hardening treatment portion
17a end portion
18 boundary portion
19 coil
20 stub shaft
L1 rotational axis
L2 imaginary line

1. A stub shaft for use with a power transmission shaft, comprising:
a flange portion welded to a pipe portion connected to a rotational shaft configured to transmit a driving force of a vehicle, the flange portion including a tubular portion and a bottom portion,
the tubular portion being hollowly formed, the tubular portion having a first end portion and a second end portion, which are both end portions in an axial direction, assuming that the axial direction is a direction along a rotational axis of the rotational shaft, the first end portion of the two end portions being welded to the pipe portion,
the bottom portion being provided on the second end portion side of the tubular portion, the bottom portion serving as a bottom of the tubular portion;
a shaft portion connected to the flange portion and having a first outer diameter portion and a second outer diameter portion,
the first outer diameter portion being connected to the bottom portion, the first outer diameter portion being formed so as to have a diameter smaller than the flange portion in a radial direction with respect to the rotational axis,
the second outer diameter portion being connected to the first outer diameter portion, the second outer diameter portion being formed so as to have a diameter smaller than the first outer diameter portion in the radial direction; and
a heat hardening treatment portion provided on a surface of the shaft portion, the heat hardening treatment portion being provided on the shaft portion side with respect to a boundary portion in the axial direction, assuming that the boundary portion is a portion where an imaginary line forming an angle of 45 degrees with the rotational axis overlaps a surface between the flange portion and the shaft portion in a cross-section passing through the rotational axis.

2. The stub shaft according to claim 1, wherein the heat hardening treatment portion is not provided on where the bottom portion side of the flange portion is located with respect to the boundary portion.

3. The stub shaft according to claim 1, wherein the heat hardening treatment portion is a high-frequency quenching portion processed by quench hardening using a high frequency.

4. The stub shaft according to claim 1, wherein the heat hardening treatment portion is a laser quenching portion processed by quench hardening using a laser.

5. The stub shaft according to claim 1, wherein an end portion of the heat hardening treatment portion is provided on a surface of the first outer diameter portion.

6. The stub shaft according to claim 5, wherein the end portion of the heat hardening treatment portion is provided on the second outer diameter portion side with respect to a central portion of the first outer diameter portion in the axial direction.

7. The stub shaft according to claim 1, wherein an inner side of the boundary portion in the radial direction is solidly formed.

8. The stub shaft according to claim 1, wherein an inner side of the boundary portion in the radial direction is hollowly formed.

9. The stub shaft according to claim 1, wherein the tubular portion is formed so as to have surface hardness equal to or lower than 80% of surface hardness of the heat hardening treatment portion.

10. The stub shaft according to claim 1, wherein a length from the rotational axis to the surface of the first outer diameter portion is longer than a length of the first outer diameter portion in the axial direction.

11. A propeller shaft comprising:
a pipe portion connected to a rotational shaft configured to transmit a driving force of a vehicle; and
a stub shaft, the stub shaft including
a flange portion welded to the pipe portion and including a tubular portion and a bottom portion,
the tubular portion being hollowly formed, the tubular portion having a first end portion and a second end portion, which are both end portions in an axial direction, assuming that the axial direction is a direction along a rotational axis of the rotational shaft, the first end portion of the two end portions being welded to the pipe portion,
the bottom portion being provided on the second end portion side, the bottom portion serving as a bottom of the tubular portion,
a shaft portion connected to the flange portion and having an intermediate portion and a thin shaft portion,
the intermediate portion being connected to the bottom portion, the intermediate portion being formed so as to have a diameter smaller than the flange portion in a radial direction with respect to the rotational axis,
the thin shaft portion being connected to the intermediate portion, the thin shaft portion being formed so as to have a diameter smaller than the intermediate portion in the radial direction, and
a heat hardening treatment portion provided on a surface of the shaft portion, the heat hardening treatment portion being provided on the shaft portion side with respect to a boundary portion in the axial direction, assuming that the boundary portion is a portion where an imaginary line forming an angle of 45 degrees with the rotational axis is connected to a surface between the flange portion and the shaft portion in a cross-section passing through the rotational axis.

12. A method for manufacturing a stub shaft,
the stub shaft including
a flange portion including a tubular portion and a bottom portion,
the tubular portion being hollowly formed, the tubular portion having a first end portion and a second end portion, which are both end portions in an axial direction, assuming that the axial direction is a direction along a rotational axis of the rotational shaft, the first end portion of the two end portions being welded to a pipe portion connected to the rotational shaft configured to transmit a driving force of a vehicle,
the bottom portion being provided on the second end portion side, the bottom portion serving as a bottom of the tubular portion,
a shaft portion connected to the flange portion and having a first outer diameter portion and a second outer diameter portion,
the first outer diameter portion being connected to the bottom portion, the first outer diameter portion being formed so as to have a diameter smaller than the flange portion in a radial direction with respect to the rotational axis,
the second outer diameter portion being connected to the first outer diameter portion, the second outer diameter portion being formed so as to have a diameter smaller than the first outer diameter portion in the radial direction, and
a heat hardening treatment portion provided on a surface of the shaft portion, the heat hardening treatment portion being provided on the shaft portion side with respect to a boundary portion in the axial direction, assuming that the boundary portion is a portion where an imaginary line forming an angle of 45 degrees with the rotational axis overlaps a surface between the flange portion and the shaft portion in a cross-section passing through the rotational axis,
the method for manufacturing the stub shaft comprising:
a placement step of placing the second outer diameter portion of the shaft portion inside an annular coil used in a heat hardening treatment; and
a high-frequency quenching step of forming the heat hardening treatment portion by moving the coil from an end portion of the second outer diameter portion to a position just before the boundary portion in the axial direction.
